(19) United States
(12) Patent Application Publication
(10) Pub. No.: US 2025/0007303 A1
(43) Pub. Date: Jan. 2, 2025

(54) RECONFIGURABLE BATTERY PACK

(71) Applicant: Apple Inc., Cupertino, CA (US)

(72) Inventors: Juntao Yao, San Jose, CA (US); Andrew J. McDowell, Menlo Park, CA (US)

(21) Appl. No.: 18/342,065

(22) Filed: Jun. 27, 2023

(51) Int. Cl. H02J 7/00; H01M 10/44; H01M 10/46; H01M 50/509

(52) U.S. Cl. CPC H02J 7/0042; H01M 10/441; H01M 10/46; H01M 50/509; H02J 7/0016

(57) ABSTRACT

A reconfigurable battery pack can include a plurality of cell stacks; a plurality of charger ports each adapted to couple to a respective charger, the plurality of charger ports including a high voltage charger port and a plurality of low voltage charger ports each corresponding to one of the plurality of cell stacks; a low voltage load port adapted to couple to one or more loads; a plurality of switches corresponding to each cell stack and allowing the cell stacks to be selectively connected for series charging at a relatively higher voltage from the high voltage charger port and to be selectively connected to the low voltage load port for discharging at a relatively lower voltage; and a battery pack controller that operates the plurality of switches responsive to signals received from at least one of a charger and the plurality of cell stacks.

### BACKGROUND

Many electrical and electronic devices employ batteries for energy storage. Such devices may employ multiple cell batteries, with cells connected in series to allow for higher operating voltages and/or cells connected in parallel to allow for higher charging and/or discharging currents.

### SUMMARY

In at least some applications, it may be desirable to provide batteries that can be charged at a relatively higher voltage and discharged at a relatively lower voltage. For example, higher battery charging voltages can allow for more energy to be delivered with a lower current, thus improving efficiency, while other operating requirements may make preferable a lower discharging voltage. Thus, it may be desirable to provide battery packs that can be reconfigured to accommodate such different charging and discharging voltages, as well as providing for isolation of faulted cells within the battery.

A reconfigurable battery pack can include a plurality of cell stacks; a plurality of charger ports each adapted to couple to a respective charger, the plurality of charger ports including a high voltage charger port and a plurality of low voltage charger ports each corresponding to one of the plurality of cell stacks; a low voltage load port adapted to couple to one or more loads; a plurality of switches corresponding to each cell stack and allowing the cell stacks to be selectively connected for series charging at a relatively higher voltage from the high voltage charger port and to be selectively connected to the low voltage load port for discharging at a relatively lower voltage; and a battery pack controller that operates the plurality of switches responsive to signals received from at least one of a charger and the plurality of cell stacks.

If a charger is connected to the high voltage charger port, the battery pack controller can operate the plurality of switches to alternate between: a first charging mode in which the plurality of cell stacks are connected in series across the high voltage charger port, at least a first cell stack is connected to the low voltage load port, and at least a second cell stack is disconnected from the low voltage load port; and a second charging mode in which the plurality of cell stacks are connected in series across the high voltage charger port, at least the second cell stack is connected to the low voltage load port, and at least the first cell stack is disconnected from the low voltage load port. Alternating between the first and second charging modes can facilitate balancing charge between the first and second cell stacks. If a charger is not connected to the high voltage charger port, the battery pack controller can operate the plurality of switches to alternate between: a first discharging mode in which at least a first cell stack is connected to the low voltage load port, and at least a second cell stack is disconnected from the low voltage load port; and a second discharging mode in which at least the second cell stack is connected to the low voltage load port, and at least the first cell stack is disconnected from the low voltage load port. Alternating between the first and second discharging modes can facilitate balancing charge between the first and second cell stacks.

Each of the plurality of cell stacks comprises a plurality of cells. The plurality of cells can include two or more cells connected in series or two or more cells connected in parallel. The plurality of switches corresponding to each cell stack can include: a high switch that allows connection of a positive terminal of the cell stack to at least one of a positive terminal of at least one charger port and the positive terminal of at least one load port; a mid switch in series with the positive terminal of the cell stack, allowing for current through the cell stack to be interrupted; and a low switch that allows connection of a negative terminal of the cell stack to at least one of a negative terminal of the at least one charger port and the negative terminal of the at least one load port.

The reconfigurable battery pack can power a switch mode converter and can allow for increased charging efficiency at the relatively higher voltage and increased Y-capacitance for electromagnetic interference mitigation by discharging at the relatively lower voltage. The plurality of cell stacks can include more than two cell stacks. The reconfigurable battery pack can further a multi-voltage port.

A reconfigurable battery pack can include a high voltage charger port adapted to couple to a charger; a low voltage load port adapted to couple to one or more loads; a plurality of cell stacks; and a plurality of switches corresponding to each cell stack and allowing the cell stacks to be selectively connected for series charging at a relatively higher voltage from the high voltage charger port and to be selectively connected to the low voltage load port for discharging at a relatively lower voltage. The reconfigurable battery pack can further include a battery pack controller that operates the plurality of switches responsive to signals received from at least one of a charger and the plurality of cell stacks.

If a charger is connected to the high voltage charger port, the battery pack controller operates the plurality of switches to alternate between: a first charging mode in which the plurality of cell stacks are connected in series across the high voltage charger port, at least a first cell stack is connected to the low voltage load port, and at least a second cell stack is disconnected from the low voltage load port; and a second charging mode in which the plurality of cell stacks are connected in series across the high voltage charger port, at least the second cell stack is connected to the low voltage load port, and at least the first cell stack is disconnected from the low voltage load port. Alternating between the first and second charging modes facilitates balancing charge between the first and second cell stacks. If a charger is not connected to the high voltage charger port, the battery pack controller can operate the plurality of switches to alternate between: a first discharging mode in which at least a first cell stack is connected to the low voltage load port, and at least a second cell stack is disconnected from the low voltage load port; and a second discharging mode in which at least the second cell stack is connected to the low voltage load port, and at least the first cell stack is disconnected from the low voltage load port. Alternating between the first and second discharging modes facilitates balancing charge between the first and second cell stacks.

Each of the plurality of cell stacks comprises a plurality of cells. The plurality of cells can include two or more cells connected in series. The plurality of cells can include two or more cells connected in parallel. The reconfigurable battery pack can further include a plurality of low voltage charging ports each corresponding to one of the plurality of cell stacks. The plurality of switches corresponding to each cell stack can include a high switch that allows connection of a positive terminal of the cell stack to at least one of a positive terminal of the high voltage charger port and a positive terminal of the low voltage load port; a mid switch in series with the positive terminal of the cell stack, allowing for current through the cell stack to be interrupted; and

a low switch that allows connection of a negative terminal of the cell stack to at least one of a negative terminal of the high voltage charger port and the negative terminal of the low voltage load port. The reconfigurable battery pack can power a switch mode converter and allow for increased charging efficiency at the relatively higher voltage and increased Y-capacitance for electromagnetic interference mitigation by discharging at the relatively lower voltage. The plurality of cell stacks can include more than two cell stacks. The reconfigurable battery pack can further include a multi-voltage port.

A method of operating a reconfigurable battery pack including a high voltage charger port, a low voltage load port, a plurality of cell stacks, and a plurality of switches corresponding to each cell stack and allowing the cell stacks to be selectively connected for series charging at a relatively higher voltage from the high voltage charger port and to be selectively connected to the low voltage load port for discharging at a relatively lower voltage can include: when a charger is connected to the high voltage charger port, alternating between: a first charging mode in which the plurality of cell stacks are connected in series across the high voltage charger port, at least a first cell stack is connected to the low voltage load port, and at least a second cell stack is disconnected from the low voltage load port; and a second charging mode in which the plurality of cell stacks are connected in series across the high voltage charging port, at least the second cell stack is connected to the low voltage load port, and at least the first cell stack is disconnected from the low voltage load port. Alternating between the first and second charging modes facilitates balancing charge between the first and second cell stacks. The method can further include, when the charger is not connected to the high voltage charger port, alternating between: a first discharging mode in which at least the first cell stack is connected to the low voltage load port, and at least the second cell stack is disconnected from the low voltage load port; and a second discharging mode in which at least the second cell stack is connected to the low voltage load port, and at least the first cell stack is disconnected from low voltage load port. Alternating between the first and second discharging modes facilitates balancing charge between the first and second cell stacks.

### BRIEF DESCRIPTION OF THE DRAWINGS

FIG. 1 schematically depicts a reconfigurable battery pack.

FIGS. 2A-2B schematically depict alternating charging modes of a reconfigurable battery pack.

FIGS. 3A-3B schematically depict alternating discharging modes of a reconfigurable battery pack.

FIG. 4 schematically depicts an alternative configuration of a reconfigurable battery pack with multiple charging ports.

FIG. 5 schematically depicts still another alternative configuration of a reconfigurable battery pack with multiple charging ports.

FIG. 6 illustrates a further reconfigurable battery pack configuration.

FIG. 7 depicts a block diagram of an electrical power system with EMI filter capacitors.

FIG. 8 depicts a plot of allowable Y-capacitance versus battery voltage for an exemplary electrical system.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one.” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

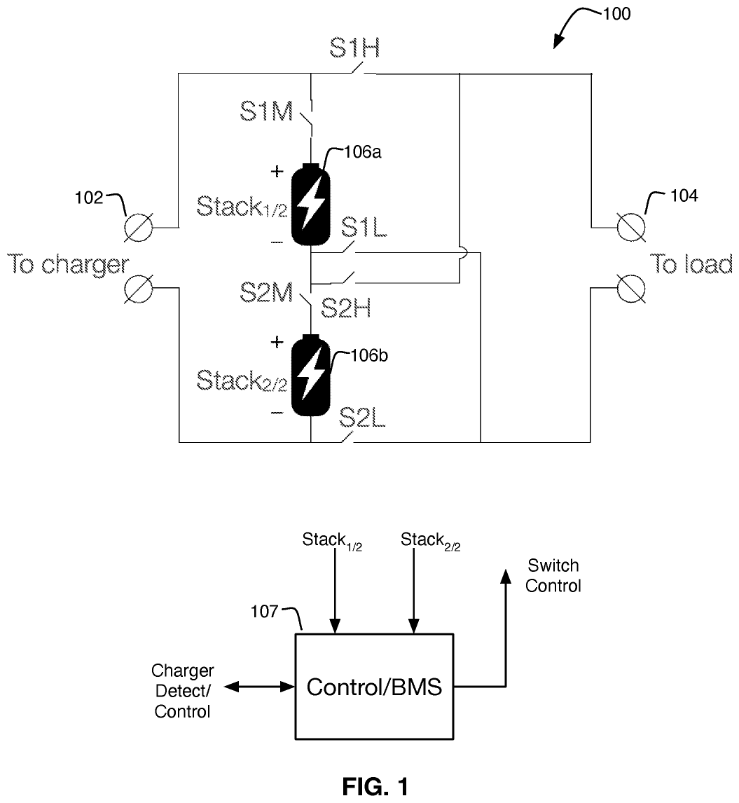

FIG. 1 schematically depicts a reconfigurable battery pack 100. Battery pack 100 can include a charger port 102 that can allow connection of the battery pack to a charger (not shown), allowing the battery pack to be charged by the charger. Battery pack 100 can also include a load port 104 that can allow connection of the battery pack to a load (not shown), allowing the load to be powered by the battery pack. Battery pack 100 can include a plurality of cell stacks 106a, 106b. Each cell stack 106a, 106b can include one or more battery cells connected in any suitable series or parallel combination as appropriate for the application. For example, multiple cells may be connected in series (sometimes known as a “string”) to allow a higher voltage to be supplied for charging and/or allow a higher voltage to be delivered for powering a load. Similarly, multiple cells may be connected in parallel (sometimes known as a “bank”) to allow a higher current to be supplied for charging and/or allow a higher current to be delivered for powering a load. As with individual cells, multiple strings (i.e., series combinations of cells) can be connected in parallel and/or multiple banks (i.e., parallel combinations of cells) can be connected in series. Thus, unless otherwise specified, as used herein, a “cell stack” can describe any combination of cell(s) in any suitable series and/or parallel configuration.

In battery pack 100, the cell stacks 106a, 106b can be selectively connected to charger port 102 and/or load port 104 by operation of a plurality of switches. For example, cell stack 106a can have associated therewith three switches S1H, S1M, and S1L. Similarly, cell stack 106b can have associated therewith three switches S2H, S2M, and S2L. These switches can be operated as described in greater detail below to facilitate different configurations of the cell stacks 106a, 106b for charging and discharging. These switches can be implemented using any suitable switching technology, such as mechanical switches or contactors or solid-state switches, such as transistors, including, for example, metal oxide semiconductor field effect transistors (MOSFETs), although other solid-state switching devices could be used as appropriate. These solid-state switching devices can be implemented using any suitable semiconductor technology, including silicon (Si), silicon carbide (SiC), gallium nitride (GaN), etc.

Also depicted in FIG. 1 is battery pack control/battery management circuitry 107 (hereinafter battery pack controller 107). Battery pack controller can be implemented using any suitable combination of analog, digital, or programmable circuits that monitor conditions associated with operation of the battery pack and regulate or control the charging operation. These circuits can be implemented in any suitable combination of discrete or integrated circuitry. In at least some embodiments, battery pack controller can be implemented using one or more microcontrollers, although other device types, such as application specific integrated circuits (ASICs), field programmable gate arrays (FPGAs), etc. could also be used.

Battery pack controller 107 can include one or more inputs that detect the presence of charger connected charger port 102. Battery pack controller 107 can also include one or more outputs that provide feedback signals to a charger connected to charger port 102, including signals relating to battery state of charge, voltage, current, temperature, etc. for individual cells, groups of cells, cell stacks, etc. In some embodiments, battery pack controller 107 can also provide control signals requesting a particular battery charging current or voltage, etc. To facilitate such operations, battery pack controller 107 can receive one or more inputs from the respective cell stacks that provide information about the state of the cell stacks, such as voltage, current, temperature, etc. Battery pack controller 107 can implement control loops or logic that allow it to determine appropriate charging currents, voltages, etc. based on the information received, which can be passed on to a charger connected to charger port 102 as described above. Additionally, battery pack controller 107 can include outputs for controlling the battery pack switches as described in greater detail below.

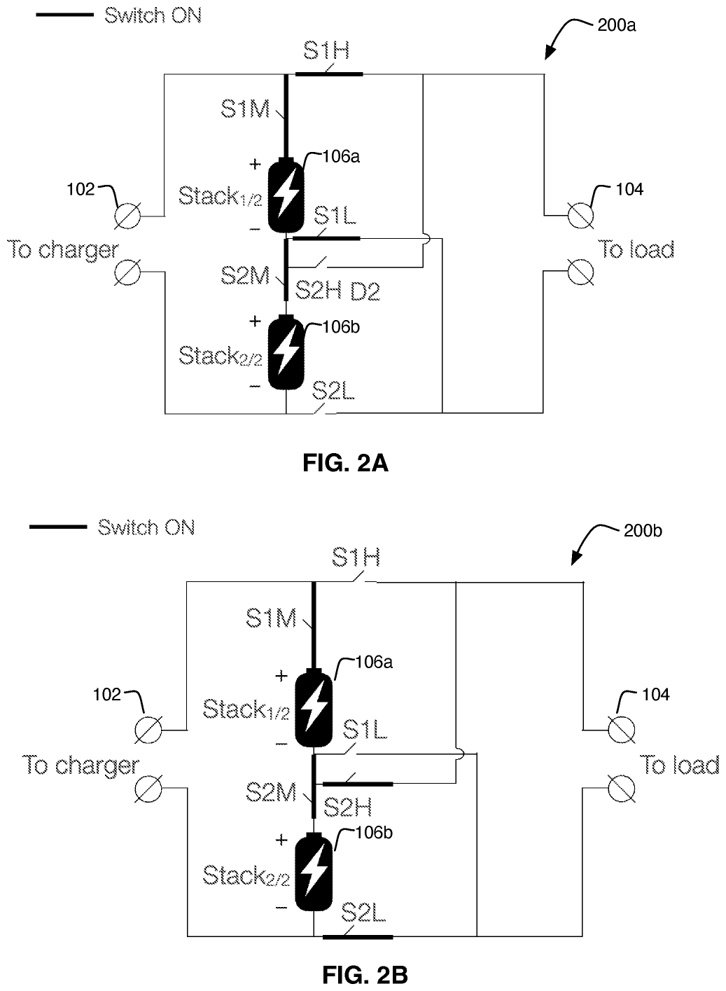

FIGS. 2A-2B schematically depict charging modes 200a, 200b of a reconfigurable battery pack 100 as described above with respect to FIG. 1. In charging mode 200a, switches SIM and S2M can be closed, allowing a charger connected to charging port 102 to charge cell stacks 106a, 106b in a series configuration. This can allow charging a higher charging voltage, allowing for higher power delivery for a given current, which can improve charging efficiency. Additionally in charging mode 200a, switches S1H and S1L can be closed, allowing cell stack 106a and/or the charger connected to charger port 102 to supply power to a load connected to load port 104. In charging mode 200a, switches S2H and S2L are open, meaning that cell stack 106b does not supply power to load port 104. Thus, depending on the specific charging currents required by the respective cell stacks and load, cell stack 106b can charge with a higher current than cell stack 106a, as the charging current through cell stack 106b is the sum of the charging current through cell stack 106a and the load current.

Similarly, in charging mode 200b, switches SIM and S2M can be closed, allowing a charger connected to charging port 102 to charge cell stacks 106a, 106b in a series configuration. As noted above, this can allow charging a higher charging voltage, allowing for higher power delivery for a given current, which can improve charging efficiency. Additionally in charging mode 200b, switches S2H and S2L can be closed, allowing cell stack 106b and/or the charger connected to charger port 102 to supply power to a load connected to load port 104. In charging mode 200b, switches S1H and S1L are open, meaning that cell stack 106a does not supply power to load port 104. Thus, depending on the specific charging currents required by the respective cell stacks and load, cell stack 106a can charge with a higher current than cell stack 106b, as the charging current through cell stack 106a is the sum of the charging current through cell stack 106b and the load current.

In at least some embodiments, alternating between charging mode 200a and charging mode 200b can allow for balancing the state of charge between cell stacks 106a, 106b. Additionally, in each of charging modes 200a, 200b, the voltage at load port 104 (i.e., the voltage supplied to the load) is approximately one-half the voltage supplied at charger port 102, which may be advantageous in some applications.

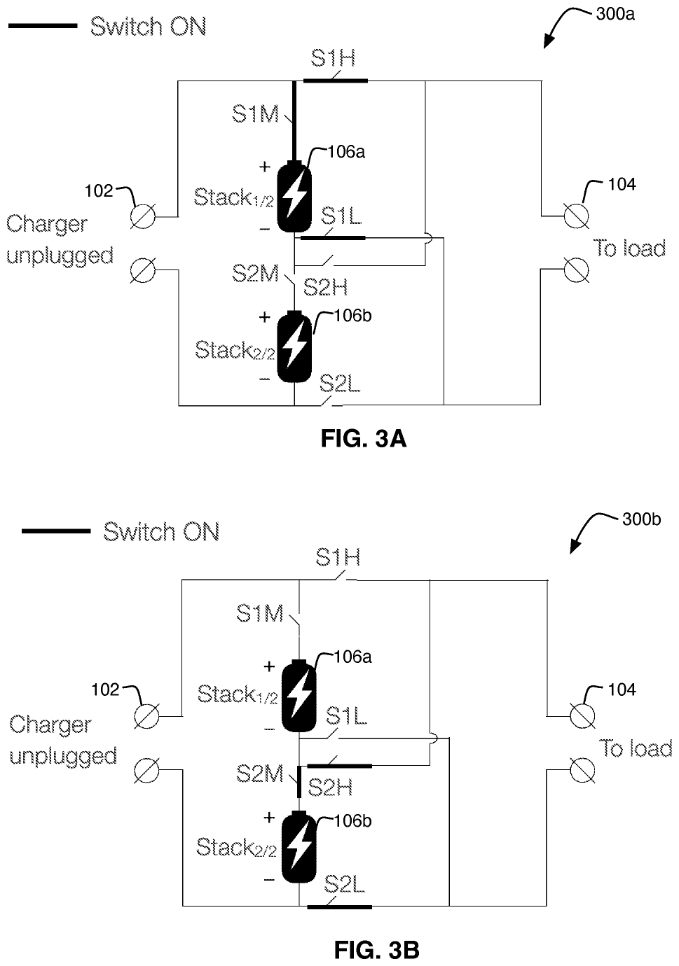

FIGS. 3A-3B schematically depict alternating discharging modes 300a, 300b of a reconfigurable battery pack 100 as described above with respect to FIG. 1. In discharging mode 300a, no charger is connected to charging port 102. Additionally, switches S1H, SIM, and S1L can be closed, allowing cell stack 106a to power a load coupled to load port 104. Additionally in discharging mode 300a, switches S2H, S2M, and S2L are open, meaning that cell stack 106b does not supply power to load port 104. Similarly in discharging mode 300b, no charger is connected to charging port 102. Conversely in discharging mode 300b, switches S2H, S2M, and S2L can be closed, allowing cell stack 106b to power a load coupled to load port 104, while in discharging mode 300a, switches S1H, SIM, and S1L are open, meaning that cell stack 106a does not supply power to load port 104.

In at least some embodiments, alternating between discharging mode 300a and discharging mode 300b can allow for balancing the state of charge between cell stacks 106a, 106b. Additionally, the ability to isolate individual cell stacks can allow for isolation of a cell stack experiencing a fault, allowing continued operation of a load connected to load port 104 in the case of such fault. In each of discharging modes 300a, 300b, the voltage at load port 104 (i.e., the voltage supplied to the load) is equal to the voltage of one cell stack 106a, 106b. In some embodiments, additional switching devices and control logic could be provided allowing cell stacks 106a, 106b to be connected in parallel for discharging operations.

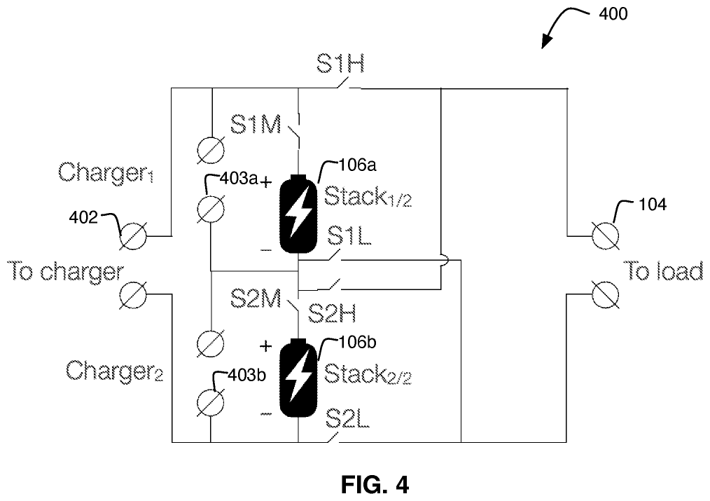

FIG. 4 schematically depicts an alternative configuration of a reconfigurable battery pack 400 with multiple charging ports. More specifically, the multiple charging ports can include a high voltage charging port 402, similar to charge port 102 as described above, which can allow for charging cell stacks 106a, 106b in series. The multiple charging ports can also include low voltage charging ports 403a, 403b, respectively corresponding to cell stacks 106a, 106b, allowing these individual cell stacks to be charged with a lower voltage (e.g., one-half the high voltage supplied to high voltage charging port 402). In other respects, configuration of battery pack 400 can be as described above with respect to battery pack 100 of FIG. 1. Likewise, charging and discharging operations may be as described above with respect to FIGS. 2A-2B and 3A-3B. Additionally, additional charging modes allowing for only a single cell stack to be charged by connecting a lower voltage charger to one of ports 403a, 403b are also possible. This may be advantageous in various applications in which different charging voltages are available.

As but one example, some electric vehicle chargers are configured for 800V operation, while many are only configured for 400V operation. If battery pack 400 included two 400V cell stacks, charging port 102 could be used in connection with an 800V charger, while charging ports 403a, 403b could be used in connection with a 400V charger. In such applications, suitable interconnect devices could simultaneously connect charging ports 403a, 403b to the 400V output of the charger, allowing cell stacks 106a, 106b to be charged simultaneously (subject to the total current constraints of the charger). As another example, small personal electronic devices such as smartphones may include a single battery cell, while larger devices, such as laptop computers, may include multiple cells in various series/parallel combinations. With the advent of universal serial bus power delivery (USB-PD), external adapters may be capable of supplying multiple output voltages; however, not all devices can supply all voltages. Thus, if a battery pack 400 were used in connection with a USB-PD charger not capable of supplying a full pack charging voltage, a configuration like that of FIG. 4 could be used to allow the lower voltage adapter to separately charge various cells/cell groups of the battery pack.

In some embodiments, additional switching circuitry could be provided to alternately apply the lower charging voltage to charging ports 403a, 403b, with corresponding operation of switches S1H, SIM, S1L, S1H, S2M, and S2L allowing for state of charge balancing in a manner similar to that described above with respect to FIGS. 2A-2B. Additionally, the configuration of battery pack 400 can extend the ability to isolate individual faulted cell stacks to the charging mode in a manner similar to the cell stack isolation in the discharging modes described above with respect to FIGS. 3A-3B. Control circuitry for battery pack 400 can be generally as described above with respect to battery pack controller 107 in FIG. 1, with additional inputs, outputs, logic or control loops as appropriate for the particular application and associated operations.

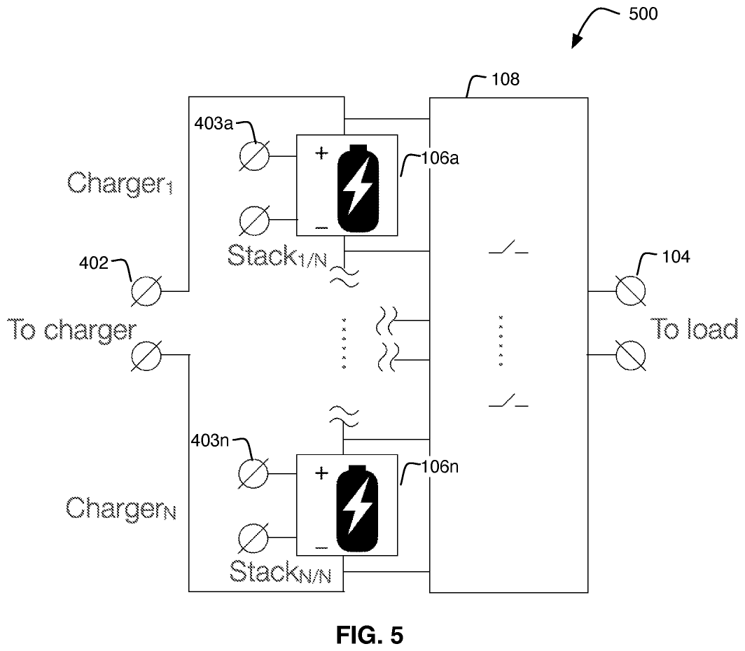

FIG. 5 schematically depicts still another alternative configuration of a reconfigurable battery pack 500 with multiple charging ports. As with the embodiments described above, battery pack 500 includes a high voltage charge port 402 and a load port 104. Battery pack 500 differs from the embodiments described above in that it can include more than two cell stacks 106a . . . 106n. Each cell stack 106a . . . 106n can have a corresponding a separate low voltage charging port 403a . . . 403n, which can provide configuration and operation as described above with respect to FIG. 4. Finally, the cell stacks 106a . . . 106n can be interconnected by switching devices making up a switch matrix 108.

Individual switching devices of switch matrix 108 are not depicted in FIG. 5, but the connection may be generally as described above, with each cell stack having a corresponding “high” switch (e.g., S1H, S2H described above). These high switches for each cell stack can allow for its positive terminal to be connected to the positive terminal of high voltage charging port 402 and/or the positive terminal of load port 104. Each cell stack can also have a corresponding “mid” switch (e.g., SIM, S2M described above) in series with the positive terminal of the cell stack, allowing for current through the cell stack to be interrupted. Finally, each cell stack can also have a corresponding “low” switch (e.g., S1L, S2L described above). These low switches for each cell stack can allow for its negative terminal to be connected to the negative terminal of high voltage charging port 402 and/or the negative terminal of load port 104. These switches for each cell stack can be selectively configured to allow for series charging in a manner similar to that described above with respect to FIGS. 2A-2B and for alternate discharging in a manner similar to that described above with respect to FIGS. 3A-3B.

In some embodiments, additional switching devices and control logic may be provided in switch matrix 108 for providing other configuration of the cell stacks 106a . . . 106n, such as connecting multiple cell stacks in parallel to provide additional current to a load connected to load ports 104 and/or to provide for simultaneous discharging. Control circuitry for battery pack 400 can be generally as described above with respect to battery pack controller 107 in FIG. 1, with additional inputs, outputs, logic, and/or control loops as appropriate for the particular application and associated operations.

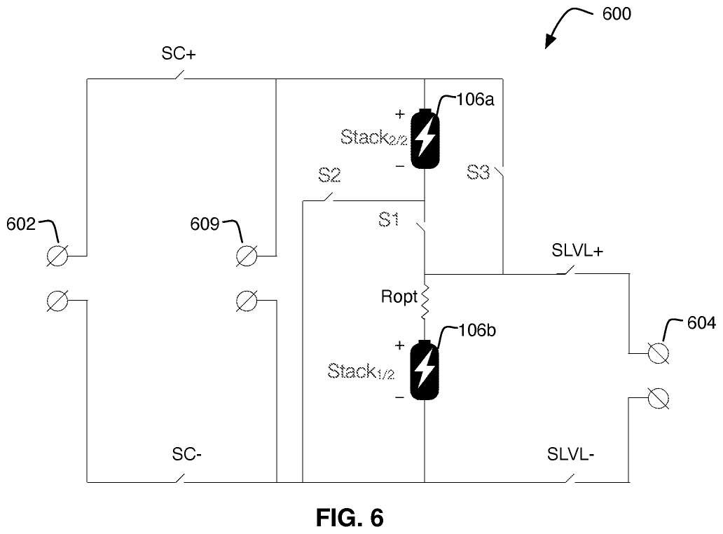

FIG. 6 illustrates a further exemplary reconfigurable battery pack 600. As above, the reconfigurable battery pack can include two cell stacks 106a, 106b, although the concept can be extended to include additional cell stacks as described above. The electrical system can include a charging port 602 as described above, which can be selectively coupled to or decoupled from the system by switches SC+, SC−. The electrical system can also include a low voltage load port 604 as described above, which can be selectively coupled to or decoupled from the system by switches SLVL+, SLVL−. Loads connected to the low voltage load port 604 can be powered by any cell stack individually or by multiple cell stacks in parallel depending on the configuration and state of the various switching devices.

Electrical system 600 can also include a dual voltage port 609, which can be bidirectional and under certain operating conditions can either receive power from or deliver power to devices coupled thereto. The voltage at dual voltage port 609 can be either a high voltage corresponding to the combined series voltage of cell stacks 106a, 106b or a lower voltage corresponding to the voltage of a single cell stack and/or cell stacks coupled in parallel. Electrical system 600 can also include a resistor Ropt that can allow for current limiting and/or the ability to operate with a faulted cell stack. In some embodiments, resistor Ropt can be replaced with a contactor or other switching device to serve the same function.

Electrical system 600 can be operated in various modes generally corresponding to those described above. As one example, electrical system 600 could be an electrified vehicle electrical system adapted for AC charging, low voltage DC charging (e.g., 400V) or high voltage DC charging (e.g., 800V). However, this is but one example and other types of electrical systems can also employ the configuration of FIG. 6. In a first charging mode, a charger (e.g. an AC charger) can be coupled to dual voltage port 609. The charger can be configured to generate a voltage sufficient to charge the cell stacks 106a, 106b in series when switch S1 is closed, with all other switches being open. Any additional loads connected to dual voltage port 609 can also be powered by the charger at the higher voltage. In an alternative “half stack” charging mode, a charger (e.g., a low voltage DC charger) can be coupled to charging port 602 and the cell stacks 106a, 106b can be charged in parallel at the lower DC voltage by closing switches S2, S3, SC+, and SC−, with all other switches being open. As yet another alternative, in a “full stack” charging mode, a charger (e.g., a high voltage DC charger) can be coupled to charging port 602, with switches S1, SC+, and SC-closed, with all other switches being left open. Finally, in a discharging mode, switches S2, S3, SLVL+, SLVL−, can be closed with all other switches open, allowing loads connected to dual voltage port 609 and low voltage load port 604 to be powered with a lower voltage corresponding to a voltage of a single cell stack, although the cell stacks may be coupled in parallel for increased capacity.

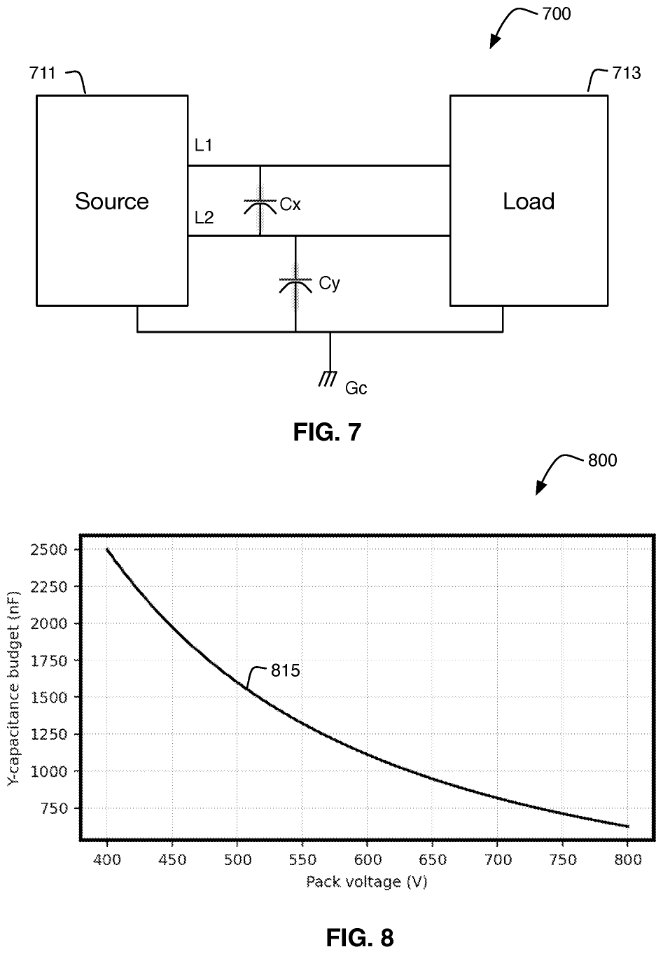

In addition to the above-described benefits of battery packs 100, 400, 500, 600 incorporating multiple cell stacks 106a, 106b, . . . , 106n and associated switching devices (S1H, S1M, S1L, S2H, S2M, S2L, 108, SC+, SC−, SLVL+, SLVL−) to allow for series charging of the cell stacks (FIGS. 2A-2B) with alternating (FIGS. 3A-3B) and/or parallel discharging of the cell stacks, further advantages of such battery packs can be achieved relating to electromagnetic interference (EMI) reduction and the use of suitable Y-capacitor sizes, as described in greater detail below. FIG. 7 depicts a block diagram of an electrical power system 700 with EMI filter capacitors. Electrical power system 700 can include a source 711 that can supply power to a load 713 via lines L1, L2. In one example, source 711 could be an AC mains supply, and load 713 could be a switching power supply that further provides power to additional devices (not shown). This particular configuration is not mandatory, as source 711 could be any suitable power source, and load 713 could be any suitable load device. Likewise, power could be supplied over more or fewer energized lines than the depicted L1, L2, and the supplied power could be DC or AC, including polyphase AC. Also depicted in FIG. 7 is a chassis ground Gc, to which each of source 711 and load 713 are connected. In some cases, the ground may also be an earth ground, although in the case of portable electronic devices, electrified vehicle applications, etc., the chassis ground may not also be an earth ground.

In various embodiments and applications electromagnetic interference (EMI) or “noise” may be present in the system. For example, such noise may be associated with the operation of switching power converters in source 711 and/or load 713. Other EMI/noise sources are also possible. In general, such EMI/noise may take two forms. Normal or differential mode noise is noise that exists on the energized lines (e.g., L1, L2) with respect to each other. Common mode noise is noise that exists on the energized lines (L1, L2) with respect to a neutral or ground (e.g., chassis ground Gc).

Various techniques for mitigating both types of noise can be used. For example, various configurations of inductors or chokes can be used to mitigate effects of both types of noise. Additionally or alternatively, various configurations of capacitors can be employed to mitigate effects of both types of noise. Some EMI mitigation capacitors may be referred to as “Cx” capacitors, which can be connected between energized lines/terminals (e.g., L1, L2). Other EMI mitigations capacitors may be referred to as “Cy” capacitors or “Y-capacitance,” which can be connected between an energized line and ground (e.g., chassis ground Cg). Although not shown in FIG. 7 for sake of brevity, a Cy capacitor may be provided between each energized conductor/terminal and ground. In general, Cx capacitors may be selected primarily to deal with normal or differential mode noise, while Cy capacitors may be selected primarily to deal with common mode noise. Generally, larger capacitance values may be more effective at EMI mitigation, at least to a point, although this may depend on particulars of a given application including the specific circuit topologies, operating conditions, and other components (e.g., chokes, etc.)

In some systems, for example systems including a chassis ground that is not connected to earth ground, it may be desirable or even necessary to limit the amount of energy that can be stored in a Y-capacitance to prevent delivering an electrical shock to the user. The energy stored in a capacitor, such as Y-capacitance Cy, is proportional to the capacitance and proportional to the square of the voltage across the capacitor. Thus, as the operating voltage of a system increases, the capacitance that can be used while staying within a particular limit decreases substantially (i.e., according to the square of the voltage). An example from an electrified vehicle application is described below with reference to FIG. 8.

More specifically, FIG. 8 depicts a plot 800 of allowable Y-capacitance versus battery voltage curve 815 for an exemplary electrical system. For example, the illustrated example can correspond to a vehicular application, in which source 711 might be a battery pack as described above with respect to FIGS. 1-6, and load 713 might be a switching power converter that converts the DC voltage supplied by such a battery pack (e.g., at load port 104) to a voltage suitable for driving a traction motor or other load associated with the electrified vehicle. In such applications, relevant standards may limit the energy that can be stored in EMI mitigation capacitance Cy to a value of 0.2 J. Thus, for an operating voltage of 400V, an energy limit of 0.2 J can correspond to a Y capacitance limit of 2500 nF (2.5 μF), while an operating voltage of 800V may reduce this value to less than 750 nF (0.75 μF). These specific numerical examples are exemplary only, and the principle discussed above is equally applicable to other applications, such as portable electronic devices, although the associated voltages could be much lower.

In any case, a battery pack configuration as described above with reference to FIGS. 1-6 can provide for operational advantages in such a system. Because such a battery pack can charge at a multiple of the system operating voltage, the advantages of higher voltage charging (e.g., improved efficiency) can be obtained. Similarly, because the operating voltage of the systems powered by such a battery pack is lower, a larger Cy capacitance can be used for EMI mitigation.

The foregoing describes exemplary embodiments of reconfigurable battery packs that can allow for higher voltage charging and lower voltage discharging. Such configurations may be used in a variety of applications but may be particularly advantageous when used in conjunction with electrified vehicles, portable electronic devices, and the like. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A reconfigurable battery pack comprising:
a plurality of cell stacks;
a plurality of charger ports each adapted to couple to a respective charger, the plurality of charger ports including a high voltage charger port and a plurality of low voltage charger ports each corresponding to one of the plurality of cell stacks;
a low voltage load port adapted to couple to one or more loads;
a plurality of switches corresponding to each cell stack and allowing the cell stacks to be selectively connected for series charging at a relatively higher voltage from the high voltage charger port and to be selectively connected to the low voltage load port for discharging at a relatively lower voltage; and
a battery pack controller that operates the plurality of switches responsive to signals received from at least one of a charger and the plurality of cell stacks.

2. The reconfigurable battery pack of claim 1 wherein if a charger is connected to the high voltage charger port, the battery pack controller operates the plurality of switches to alternate between:
a first charging mode in which the plurality of cell stacks are connected in series across the high voltage charger port, at least a first cell stack is connected to the low voltage load port, and at least a second cell stack is disconnected from the low voltage load port; and
a second charging mode in which the plurality of cell stacks are connected in series across the high voltage charger port, at least the second cell stack is connected to the low voltage load port, and at least the first cell stack is disconnected from the low voltage load port;
wherein alternating between the first and second charging modes facilitates balancing charge between the first and second cell stacks.

3. The reconfigurable battery pack of claim 1 wherein if a charger is not connected to the high voltage charger port, the battery pack controller operates the plurality of switches to alternate between:
a first discharging mode in which at least a first cell stack is connected to the low voltage load port, and at least a second cell stack is disconnected from the low voltage load port; and
a second discharging mode in which at least the second cell stack is connected to the low voltage load port, and at least the first cell stack is disconnected from the low voltage load port;
wherein alternating between the first and second discharging modes facilitates balancing charge between the first and second cell stacks.

4. The reconfigurable battery pack of claim 1 wherein each of the plurality of cell stacks comprises a plurality of cells.

5. The reconfigurable battery pack of claim 4 wherein the plurality of cells includes two or more cells connected in series or two or more cells connected in parallel.

6. The reconfigurable battery pack of claim 1 wherein the plurality of switches corresponding to each cell stack includes:
a high switch that allows connection of a positive terminal of the cell stack to at least one of a positive terminal of at least one charger port and the positive terminal of at least one load port;
a mid switch in series with the positive terminal of the cell stack, allowing for current through the cell stack to be interrupted; and
a low switch that allows connection of a negative terminal of the cell stack to at least one of a negative terminal of the at least one charger port and the negative terminal of the at least one load port.

7. The reconfigurable battery pack of claim 1 wherein the reconfigurable battery pack powers a switch mode converter and allows for increased charging efficiency at the relatively higher voltage and increased Y-capacitance for electromagnetic interference mitigation by discharging at the relatively lower voltage.

8. The reconfigurable battery pack of claim 1 wherein the plurality of cell stacks comprises more than two cell stacks.

9. The reconfigurable battery pack of claim 1 further comprising a multi-voltage port.

10. A reconfigurable battery pack comprising:
a high voltage charger port adapted to couple to a charger;
a low voltage load port adapted to couple to one or more loads;
a plurality of cell stacks; and
a plurality of switches corresponding to each cell stack and allowing the cell stacks to be selectively connected for series charging at a relatively higher voltage from the high voltage charger port and to be selectively connected to the low voltage load port for discharging at a relatively lower voltage.

11. The reconfigurable battery pack of claim 10 further comprising a battery pack controller that operates the plurality of switches responsive to signals received from at least one of a charger and the plurality of cell stacks.

12. The reconfigurable battery pack of claim 11 wherein if a charger is connected to the high voltage charger port, the battery pack controller operates the plurality of switches to alternate between:
a first charging mode in which the plurality of cell stacks are connected in series across the high voltage charger port, at least a first cell stack is connected to the low voltage load port, and at least a second cell stack is disconnected from the low voltage load port; and
a second charging mode in which the plurality of cell stacks are connected in series across the high voltage charger port, at least the second cell stack is connected to the low voltage load port, and at least the first cell stack is disconnected from the low voltage load port;
wherein alternating between the first and second charging modes facilitates balancing charge between the first and second cell stacks.

13. The reconfigurable battery pack of claim 11 wherein if a charger is not connected to the high voltage charger port, the battery pack controller operates the plurality of switches to alternate between:
a first discharging mode in which at least a first cell stack is connected to the low voltage load port, and at least a second cell stack is disconnected from the low voltage load port; and
a second discharging mode in which at least the second cell stack is connected to the low voltage load port, and at least the first cell stack is disconnected from the low voltage load port;
wherein alternating between the first and second discharging modes facilitates balancing charge between the first and second cell stacks.

14. The reconfigurable battery pack of claim 10 wherein each of the plurality of cell stacks comprises a plurality of cells.

15. The reconfigurable battery pack of claim 14 wherein the plurality of cells includes two or more cells connected in series.

16. The reconfigurable battery pack of claim 14 wherein the plurality of cells includes two or more cells connected in parallel.

17. The reconfigurable battery pack of claim 10 further comprising a plurality of low voltage charging ports each corresponding to one of the plurality of cell stacks.

18. The reconfigurable battery pack of claim 10 wherein the plurality of switches corresponding to each cell stack includes:
a high switch that allows connection of a positive terminal of the cell stack to at least one of a positive terminal of the high voltage charger port and a positive terminal of the low voltage load port;
a mid switch in series with the positive terminal of the cell stack, allowing for current through the cell stack to be interrupted; and
a low switch that allows connection of a negative terminal of the cell stack to at least one of a negative terminal of the high voltage charger port and the negative terminal of the low voltage load port.

19. The reconfigurable battery pack of claim 10 wherein the reconfigurable battery pack powers a switch mode converter and allows for increased charging efficiency at the relatively higher voltage and increased Y-capacitance for electromagnetic interference mitigation by discharging at the relatively lower voltage.

20. The reconfigurable battery pack of claim 10 wherein the plurality of cell stacks comprises more than two cell stacks.

21. The reconfigurable battery pack of claim 10 further comprising a multi-voltage port.

22. A method of operating a reconfigurable battery pack including a high voltage charger port, a low voltage load port, a plurality of cell stacks, and a plurality of switches corresponding to each cell stack and allowing the cell stacks to be selectively connected for series charging at a relatively higher voltage from the high voltage charger port and to be selectively connected to the low voltage load port for discharging at a relatively lower voltage, the method comprising:
when a charger is connected to the high voltage charger port, alternating between:
a first charging mode in which the plurality of cell stacks are connected in series across the high voltage charger port, at least a first cell stack is connected to the low voltage load port, and at least a second cell stack is disconnected from the low voltage load port; and
a second charging mode in which the plurality of cell stacks are connected in series across the high voltage charging port, at least the second cell stack is connected to the low voltage load port, and at least the first cell stack is disconnected from the low voltage load port;
wherein alternating between the first and second charging modes facilitates balancing charge between the first and second cell stacks; and
when the charger is not connected to the high voltage charger port, alternating between:
a first discharging mode in which at least the first cell stack is connected to the low voltage load port, and at least the second cell stack is disconnected from the low voltage load port; and
a second discharging mode in which at least the second cell stack is connected to the low voltage load port, and at least the first cell stack is disconnected from low voltage load port;
wherein alternating between the first and second discharging modes facilitates balancing charge between the first and second cell stacks.
